(19) United States
(12) Patent Application Publication
(10) Pub. No.: US 2013/0097146 A1
(43) Pub. Date: Apr. 18, 2013

(54) PERSONALIZED RANKING OF CATEGORIZED SEARCH RESULTS

(71) Applicant: MEDIO SYSTEMS, INC., Seattle, WA (US)

(72) Inventors: Damon Lanphear, Vashon Island, WA (US); Rodrick Megraw, Seattle, WA (US); Daniel Hendrick, Bellevue, WA (US)

(73) Assignee: MEDIO SYSTEMS, INC., Seattle, WA (US)

(21) Appl. No.: 13/646,587

(22) Filed: Oct. 5, 2012

Related U.S. Application Data
(60) Provisional application No. 61/543,787, filed on Oct. 5, 2011.

(51) Int. Cl. G06F 17/30

(52) U.S. Cl. CPC G06F 17/30864
USPC 707/706; 707/734

(57) ABSTRACT

Query results are mapped onto domains comprising a plurality of predetermined conceptual groupings wherein the query results comprise database records identified by a search engine in response to a current search query. A population ranking is determined for the query results such that the query results are mapped onto the domains in accordance with query-click behavior collected from a user population for the current search query. A user ranking is then determined for the query results such that the query results are mapped onto the domains in accordance with query-click behavior collected from the user for prior search queries not including the current search query. Lastly, a merged ranking of the query results is generated according to the population ranking and the user ranking

### CROSS-REFERENCES TO RELATED APPLICATIONS

This application is a non-provisional patent application that claims priority from co-pending U.S. Provisional Application Ser. No. 61/543,787 filed on Oct. 5, 2011, titled “Personalized Ranking of Categorized Search Results”, which is hereby expressly incorporated by reference in its entirety for all purposes.

### BACKGROUND

Contemporary search engines can process search queries in a number of different areas of interest. Some commonly used synonyms for a search “area of interest” would include “domain” and “category”. In the discussion herein, it will be understood that a search engine operates over a particular database or collection of data, and it will be understood that the database over which a search engine operates may be limited to a search “area of interest”, “domain”, or “category” that is a subset of all available data. For example, search engines such as Google and Yahoo! have an available database that comprises virtually all Web pages that are publicly available. The “domain” or “category” over which these search engines can be directed could be limited, such as being limited to data about maps, weather, local business listings, news, sports, travel, or entertainment, or the domains could be expansive, such as covering substantially all the World Wide Web itself.

Search engines can easily determine the intended domain for many search queries. For example, search queries that contain place names like “Pizza Seattle” are likely to be targeted to information about businesses (such as “pizza”) that are local to the place name (“Seattle”). There are search queries, however, that cannot be easily mapped to a domain or category because they may map equally well to multiple domains. These types of queries are said to be “ambiguous”. An example of an ambiguous search query is the word “Paris”, which may be intended to seek information about a city or about a celebrity in any number of domains.

Resolving ambiguous queries requires some knowledge about the intent of individual users. Understanding general areas of interest of a user as the areas of interest relate to search queries can inform the process of disambiguation of a query. For example, if it is understood that a specific user is interested in travel information, then disambiguating a search query for “Paris” is likely to focus on an interpretation of “Paris” as the name of a city rather than the name of a celebrity.

The intent or target of a query may vary significantly between different users and over time. Knowledge of user intent must therefore be specific to individual users in order to adequately represent the diversity of user interest that may be contained in a query. Similarly, there may be widespread shifts in the intent of queries that occur in response to particular events in time. Effective search query processing should take into account differences among users and at different times.

### SUMMARY

As disclosed herein, query results are mapped onto domains comprising a plurality of predetermined conceptual groupings wherein the query results comprise database records identified by a search engine in response to a current search query. A population ranking is then determined for the query results such that the query results are mapped onto the domains in accordance with query-click behavior collected from a user population for the current search query. A user ranking is then determined for the query results such that the query results are mapped onto the domains in accordance with query-click behavior collected from the user for prior search queries not including the current search query. Lastly, a merged ranking of the query results is generated according to the population ranking and the user ranking In this way, search engine results can be organized across multiple domains in response to a query from a user, such that the search engine results are displayed according to which results domain or category is most appropriate for the given query. If desired, the domain ranking can be known to the search engine prior to beginning the search. By identifying the most appropriate domain, the search engine can display the most relevant result in a ranked ordering. This saves the end user the time of sifting through a set of search engine results across multiple domains in order to surface the most relevant search result.

According to the disclosed technique, user intent is discerned according to collected query-click behavior over a population for substantially the same query for search domains and according to collected query-click behavior for the user independently of the current search, and then a merged ranking is determined that produces a ranking according to both the population ranking and the user ranking.

Embodiments of the present invention acquire knowledge about user intent regarding search queries by recording user actions comprising clicks/selections from the search engine frontend, communicating the recorded user actions to a database and then, for a subsequent user search query, computing a ranking of the search query results according to the database for the user and providing the ranking of results to the search engine frontend to effect the display of the results.

Other features and advantages of the present invention should be apparent from the following description of exemplary embodiments, which illustrate, by way of example, aspects of the invention.

### BRIEF DESCRIPTION OF THE DRAWINGS

FIG. 1 is a block diagram representation of a system constructed in accordance with the present invention.

FIG. 2 is a flow diagram that illustrates the operations performed by the FIG. 1 system.

FIG. 3 is a flow diagram that illustrates the operations performed by the Ranking System shown in FIG. 1.

FIG. 4 is a block diagram representation of details in the Ranking System shown in FIG. 1.

### DETAILED DESCRIPTION

The present invention provides a system and technique for ranking search engine results that are grouped by domains, or conceptual categories, in a way that takes into account the intent of a query for a specific user over a period of time. The system builds knowledge about the intent of individual users by observing expressions of interest in a search engine user interface over a larger population of users. A search engine user interface typically includes a mechanism for a user to be presented with search results and to select items or links in that presentation. The user interface typically comprises a browser application that is presented in a computer display. The user will typically express interest in an item by selecting items or links in the user interface. The search engine user interface responds to selections by displaying more detailed information about each selection, such as by retrieving a linked page over the World Wide Web. As described further below, user interest is recorded and associated with an individual user, for a specific query and at a moment in time, by collecting such “query-click” behavior as a user views the search results and makes selections. The collection of user interest query-click behavior is stored and later is processed by translating the record of user interest into a ranking for the domains or categories expressed in a search result for a given search query.

A system that collects the user query-click behavior includes a recording unit for recording user interest in a search user interface, an event system to communicate the user interest “events” to a system for storing and aggregating the record of user interest, a computing unit for computing a ranking of categorized search results for a given query and user, and a communicating system for communicating that ranking to the search engine to affect the display of search results.

In this way, the ranking of search results is personalized for the end user, such that the personalization is based on a dynamic interpretation of past behavior, and that the system is able to adapt to changes in behavior as they occur in real-time.

Block Diagram of the System

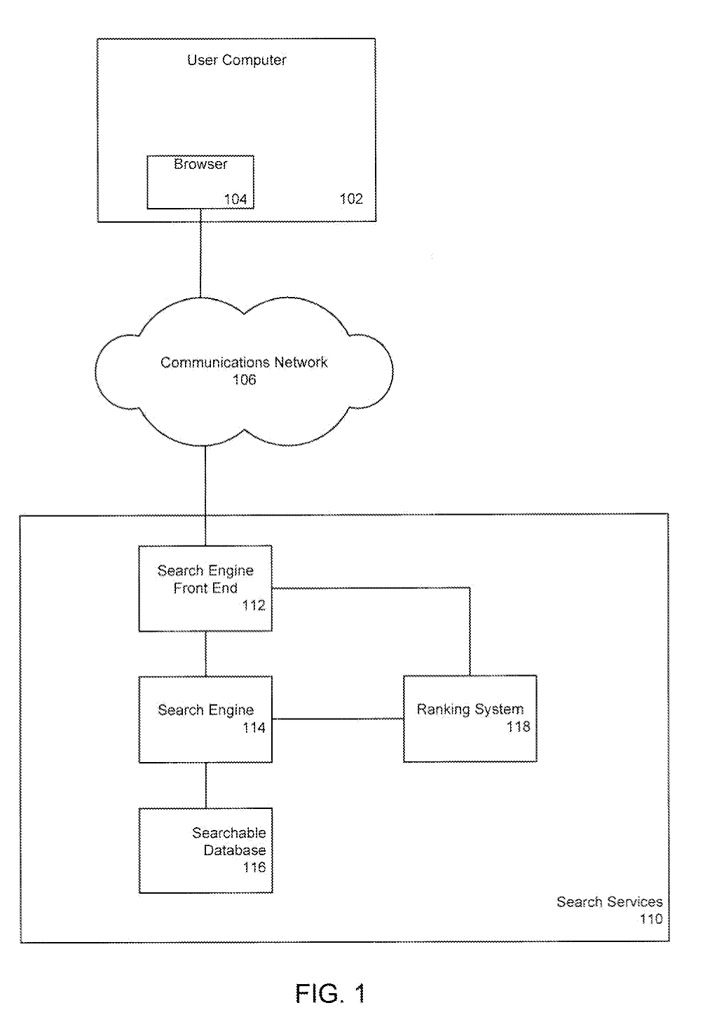

FIG. 1 is a block diagram representation that shows a user computer 102 having an operating system that supports execution of a browser application 104. The user computer 102 communicates over a communications network 106 with a search services system 110. The user computer may comprise, for example, a desktop or laptop or netbook or other computing platform that can receive user inputs and communicate with the search services system. The communications network 106 can comprise, for example, the Internet, or an intranet, or a system bus, or other means for supporting communication between the browser 104 and the search services system 110.

At the search services system 110, a search engine front end 112 communicates with the user computer 102 over the network 106. The search engine front end typically comprises the search engine portal display page that is displayed in the browser 104 at the user computer 102. The search engine front end 112 is usually generated by the search engine 114, which receives input in the form of search queries from the front end and performs a search over a searchable database 116 in response to the search queries. Results of the search queries are collected by the search engine and are provided back to the user computer 102 via the search engine front end 112 and network 106. The search query results are typically provided as a listing of database records in the form of links from which a user can make selections for retrieval of an associated database record.

In the illustrated system of FIG. 1, a ranking system 118 receives query-click input from the search engine front end 112. The query-click input comprises messages that are created in response to a user selection of a database record from among a listing of database records in query results. That is, when a user retrieves a database record (e.g. Web page) by clicking on a link in the list of search query results, a query-click input is generated. The message includes information about the query, the clicked link, a categorization of the query and result, the time of the click action, and the user. The user may comprise a member of a user population over which statistics will be collected. If desired, user identity can be masked or hidden, or maintained according to encoding, to ensure privacy. Thus, in FIG. 1, the search engine 114 is the system component that receives user queries from the search engine front end 112 and executes them against instances of the searchable database 116 component and produces a ranked list of results from the query processing. The ranking system 118 then re-ranks the results based on a personalization algorithm and returns the re-ranked results to the search engine front end 112 to generate results, which are provided to the user. The searchable database 116 may comprise a database search service 110 of the system provider, or the searchable database 116 may comprise a search service of a third party provider, such as search services from Google, Yahoo, Bing, as well as searchable databases containing data such as, but not limited to: weather information, news articles, images, ringtones, music, applications, movies, games, and the like, whose search service results are received by the system provider at the search services 110.

The categorization of the query and result corresponds to a predetermined listing or grouping of conceptual domains or categories of search results. The categorization into domains or categories can be structured, for example, into domains and categories such as maps, weather, local business listings, news, sports, travel, or entertainment, and the like. The database over which the query will be searched can comprise smaller collections such as specialized libraries of information, or the database can be more expansive, such as covering substantially all the pages available over the World Wide Web itself. Some of the more expansive search results can be provided by general interest search engines such as Google, Yahoo!, Bing, and Alta Vista. Thus, the query-click message will identify the domain or category onto which the selected database record is mapped.

The query-click messages are maintained by the ranking system 118 according to the conceptual domains on which the respective query-click messages are mapped. For example, a message that is mapped onto the domain of “weather” will be identified with that mapping. The ranking system also generates statistics on the list of query-click messages. The statistics will reflect information such as search query terms, time and date of the query, link addresses on the network, page ranking and search term ranking, and the like. These statistics indicate query-click behavior of the user population from whom the query-click behaviors (responses) were collected.

System Operation

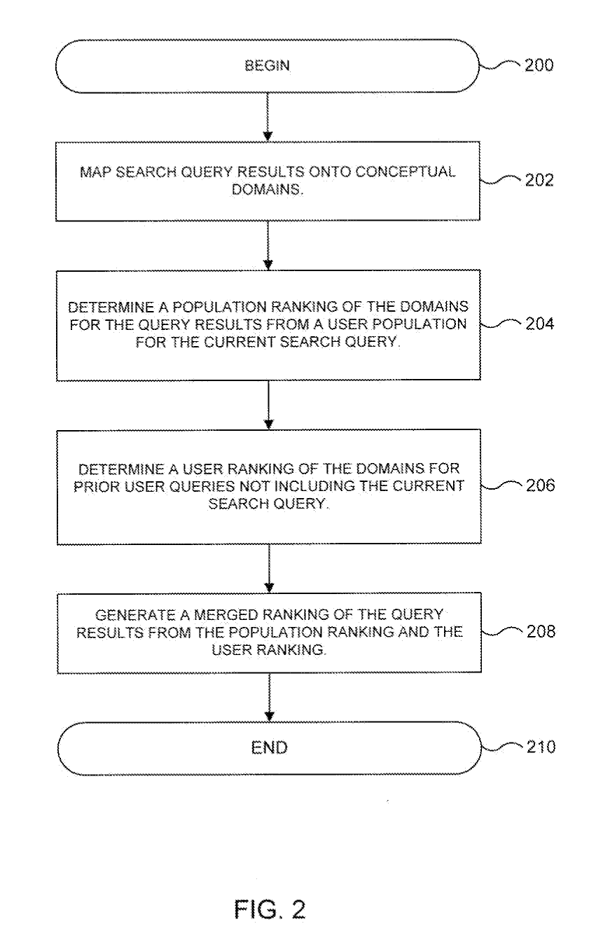

FIG. 2 is a flow diagram that illustrates the operations performed by the FIG. 1 system when processing a current user search query. The operation generally follows a sequence of ranking the query results as mapped onto conceptual domains according to a population ranking (independent of the user who submitted the current search query) and then ranking the query results as mapped onto conceptual domains according to prior query-click behavior of the user who submitted the current query, followed by merging of the population ranking and the user ranking to provide a merged ranking

With reference to FIG. 2, operation begins at box 200 and proceeds with mapping the search query results onto the conceptual domains at box 202. The domains may be generated by human analysis and effort, or can be generated by automatic analysis of documents, or can be generated by a combination of techniques. Next, at box 204, a population ranking of the conceptual domains is determined for the query results. When a user clicks on an item of the search results for the current search query, the clicked item will be mapped onto one of the conceptual domains and a collection of the resulting data will reflect query-click behavior of multiple users over an entire user population for the search query. That is, the mapping information is determined by the query-click behavior of a population of users for prior searches corresponding to the current search query. The query information can be provided by parsing the current search query into its constituent terms (words) and associating the search results with each of the search terms. Other techniques for identifying prior searches that correspond to the current search will be known to those skilled in the art.

At box 206, a user ranking of the domains is determined for prior user queries not including the current search query. That is, for the particular user who has provided the current search query, prior query-click behavior of that user is consulted in determining the mapping of the current search query. At box 208, the system generates a merged ranking of the query results according to the population ranking and the user ranking

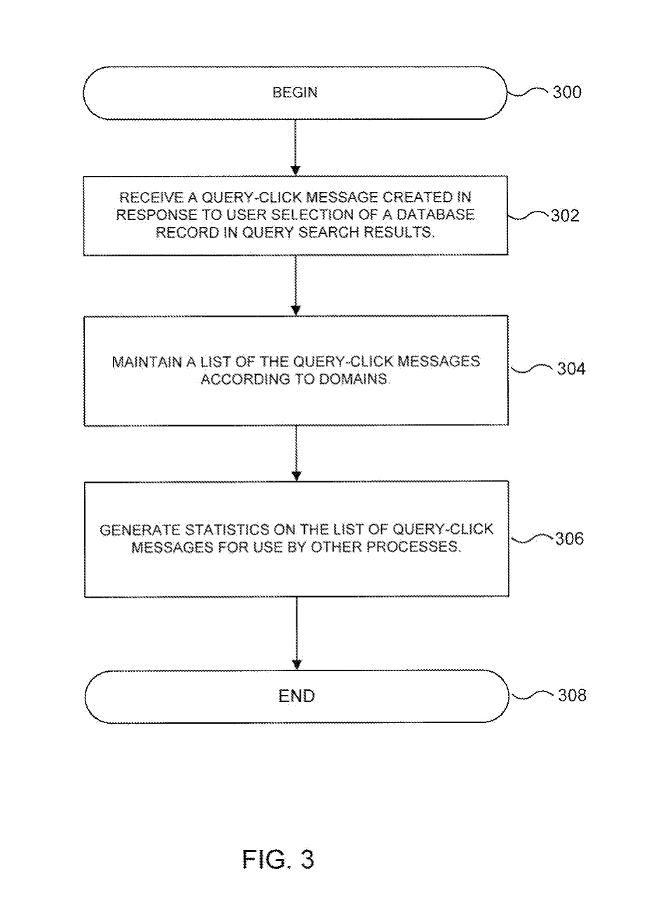

FIG. 3 is a flow diagram that illustrates the operations performed by the ranking system 118 shown in FIG. 1 to collect the query-click behavior data for the general user population. The operation begins at box 300 with the ranking system receiving a query-click message in response to user selection of a database record in the initial query search results. For any list of query search results, and for each user who is a member of the user population over which the data is being collected, selection of a link to a database record (Web page) in the query results will automatically generate a query-click message. That is, the search engine front end 112 (see FIG. 1) generates the query-click messages and passes them to the ranking system 118.

In FIG. 1, the line between the search engine 114 and the ranking system 118 indicates the passing of ranked query search results from the search engine to the ranking system. After receiving the query search results from the search engine, the ranking system utilizes its store of accumulated query-click messages to perform a personalized re-ranking of the query search results and returns the re-ranked results to the search engine front end 112. In this way, the ranking system receives and stores query-click messages asynchronously from the process of producing the re-ranked results. The re-ranked results for a given request are calculated based on the query-click messages received and stored up to that point. That is, a query-click message is not necessarily received as part of the same request transaction to produce the re-ranked results.

It is anticipated that users may be recruited to accept membership in the user population and, in exchange for search benefits, the member users will have their query-click behavior monitored and collected. The query-click message will identify the conceptual domain onto which the selected database record is mapped.

At the next operation of FIG. 3, at box 304, a list of the query-click messages according to the conceptual domains on which the messages are mapped is maintained. At the next operation, box 306, statistics on the query-click messages are generated. The generated statistics are then available to other processes of the search services system, as described further below.

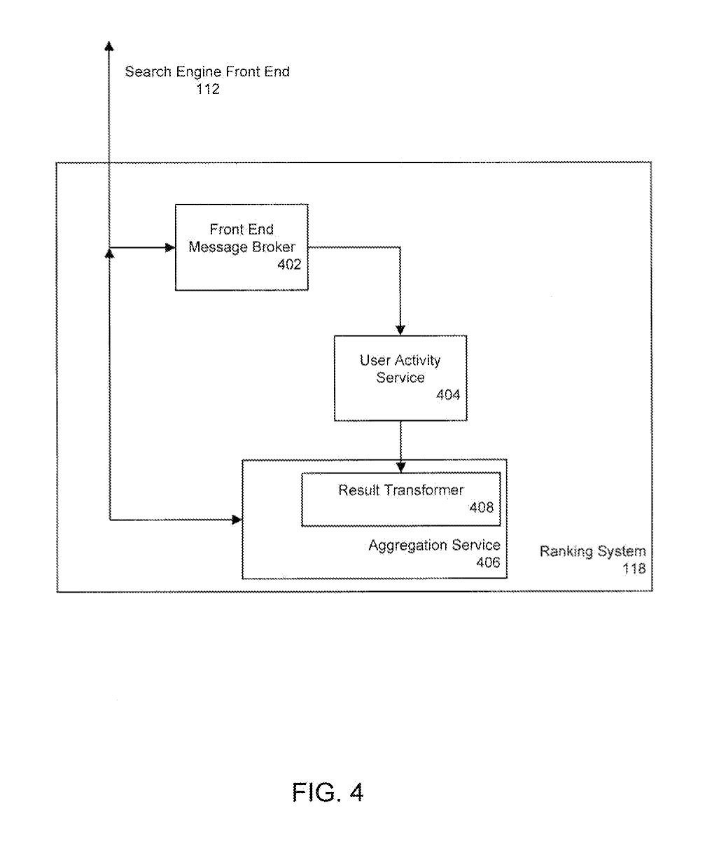

FIG. 4 is a block diagram representation of details in the ranking system 118 shown in FIG. 1. FIG. 4 shows that a front end message broker 402 receives query-click messages from the search engine front end 112 (see FIG. 1). The message broker provides the messages to a user activity service 404 that collects the messages, maintains them for access, and generates statistical information about the messages. An aggregation service 406 receives the statistical information from the user activity service when needed by the result transformer 408, which the user activity service hosts. The result transformer can adjust the ranking of the search results according to the conceptual ranking onto which the results are mapped. The aggregation service 406 then provides the adjusted ranked results to the search engine front end 112 for presentation to the user at the display of the user computer 102 (see FIG. 1).

Additional Details of the System Operation

The ranking system functions by accumulating statistics on selections of database records made by the user in the front end user interface. Database record selection events occur when a user selects a record from the search results listing in the search user interface. The search results listing may be provided, for example, in a variety of viewing options such as list view, category view, or detail view. When a user selects a database record, the search engine front end creates an event object that represents that selection event. The event object is then set over the network to the message broker. The message broker maintains queues of messages to which one or more other services can listen. These message queues are called “topics”.

The user activity service listens to a specific topic for events from the search engine front end. As event objects arrive, the message broker forwards those event objects to the user activity service. The user activity service builds statistics on these events for the user, query, and database record selected and records the events in a journal for recovery. The user activity service can be queried by other services to get statistical information about user selections.

The aggregation service hosts the result transformer. The result transformer is the component that re-ranks the search results according to a computational process that takes into account the history of user selection of results in response to search queries. The history of user selection is collected by the search service system.

Message Broker

The message broker is implemented using the ActiveMQ package, which is generally available for installation on computing systems with either the Microsoft Windows operating system or various distributions of the Linux operating system. More information about ActiveMQ is available at the ActiveMQ website at the URL of //activemq.apache.org.

The message broker supports the JMS protocol. The search engine front end sends events to the message broker via JMS over the TCP network protocol. Events are guaranteed to arrive, and to arrive in order of transmission. At the message broker, the events are stored in a queue called a “topic”. Multiple remote services can listen for events on this topic. As events arrive at the topic they are propagated to each of the listeners. Configurations exist that allow the listener to request to be “caught-up” from a certain point in time. This allows listeners to receive events that they may have missed while being restarted, or otherwise down for some reason.

The message broker can be inspected via its administrative interface to get the state of its topics, and can include counts of the number of events seen on each topic.

The search engine front end is configured with the network location of the message broker, as well as the location of the user activity service. The search engine front end publishes events to the message broker, and the user activity service consumes those events.

Details of the User Activity Service

The user activity service is a REST Web Service. The service listens to a specific message broker topic for selection event objects from the search engine front end. As event objects arrive at the user activity service, the service records the events into an in-memory data structure in a summarized form and into an on-disk journal in complete form. The summarized form consists of summations of a user's click on an item's provider identification for a given query. The summations are organized by user and by query. This is to support the ranking result transformer, which uses the summation to re-rank search results at the level of provider identification for a specific user and/or a specific query string.

The summations are kept over a configurable window, so that not all activity is kept by the user activity service. The service expires old events as new events arrive for each user and query. This prevents the statistics from being too strongly influenced by historical data when new data are assumed to be more relevant. Further, because the summary statistics are held in memory, generally only a fixed number of summations may be stored. This fixed number for users and queries is also configurable.

The user activity service exposes a REST interface to allow for easy inspection of the state of summary statistics using the browser, a command line HTTP client, a script, or a Java application. A variety of URL formats are supported. Processing is made easier by having all returned documents in plain text and integer values without further information to facilitate processing without requiring parsing or special markup handling.

The user activity service supports a form of persistence. As event objects arrive at the service they are written into an event journal. The journal may be stored on disk or on a network data store. When the service is restarted after an outage or maintenance operation, the journal is read in and the state of the summary statistics is restored from the journal. This same mechanism can be used to “prime” a User Activity Service into a known state by using a prebuilt event journal.

Aggregation Service

The aggregation service is configured with an instance of the result transformer. The result transformer communicates with the user activity service using its REST interface to gather summary statistics for the user id and/or query that surface the result set that will be re-ranked. Those statistics are then used to rank the results.

Search Engine Front End

The search engine front end sends event objects to the message broker as the user clicks on database record links in the search user interface. These event objects contain the record identifier, user identifier, and query related to the selected item. In the illustrated embodiment, the event objects are sent to the message broker on the topic called “uSearch Front End Activity”. The event objects are sent using JMS over TCP, and are serialized Java objects as they traverse the network. Record selection events are triggered whenever a user selects a database record action link in the front end user interface.

Ranking of Conceptual Domains

For any given user, the query space over which a search query may be submitted is large and sparse. The ranking system described herein uses query-click behavior by the entire user population to inform domain ranking For any particular user, user-click behavior is utilized to capture domain preferences that are independent of the search query. The domain ranking of the original (raw) search results are merged with domain rankings based on user population query-click behavior and user query-click behavior to produce a final ranking The operations for providing the ranking are described in greater detail in the pseudo-code below.

```
1. For each conceptual domain represented in the search results, compute
the probability of a click on a result in the domain given the current search
query, where s = smoothing count, given by:
    p(click | query) = s + no. of clicks on results from the query in the
    domain / no. of domains * s + no. of clicks on results form the query
    in all domains,
wherein the smoothing count is a predetermined value selected according
to desired fidelity or scaling of results.
2. Compute a ranking of the domains by p(click | query).
3. For each pod in the results, wherein a “pod” is a conceptual domain as
described above, comprising a grouping of search results relating to a
particular source or topic, compute the probability of a click on a result
in the pod given the current user, where s = smoothing count, given by:
    p(click | user) = s + no. of clicks by the user on results in the
    domain / no. of domains * s + no. of clicks by the current user on
    results in all domains
4. Compute a ranking of the pods by p(click | user).
5. For each domain in the results, compute a merged score “ms” that is a
combination of the original rank of the conceptual domain, its rank by
p(click | query), and its rank by p(click | user), for:
ro = original ranking of search results on conceptual domains
rq = rank by p(click | query)
ru = rank by p(click | user)
wrq = heuristic weight of rq in final rank
wru = heuristic weight of ru in final rank
ms = 1 / (ro + 1) + wrq / (rq + 1) + wru / (ru + 1)
6. Compute a final ranking of the domains from highest ms score to
lowest ms score.
7. OPTIONAL: recompute final ranking “rf” of domains such that no
domain has moved up or down by more than m places, where:
m = max allowed change in rank either up or down
rf = max(min(rank by ms, ro + m), ro − m)
```

Ranking Interface for Search

The domain ranking interface to search will simply take the user, query, and a ranked list of domains, and will return a re-ranked list of pods. This interface ensures that there is no dependency of the personalized ranking system on any scores used by the search system to calculate the original pod ranking

The components described above, such as the respective blocks of FIG. 1 and FIG. 4, may each be implemented as separate or integrated computer devices. Each computer device of the FIG. 1 and FIG. 4 components may comprise hardware elements that can be electrically coupled via a system bus (or may otherwise be in communication, as appropriate). The hardware elements can include one or more central processor units (CPUs), including without limitation one or more general-purpose processors and/or one or more special-purpose processors (such as digital signal processing chips, graphics acceleration chips, and/or the like); one or more input devices, which can include, without limitation, a mouse, a keyboard, and/or the like; and one or more output devices, which can include without limitation a display device, a printer, and/or the like.

Each computer device may further include (and/or be in communication with) one or more storage devices, which can comprise, without limitation, local and/or network accessible storage and/or can include, without limitation, a disk drive, a drive array, an optical storage device, solid-state storage device such as a random access memory (“RAM”), and/or a read-only memory (“ROM”), which can be programmable, flash-updateable, and/or the like. The computer devices may also include a communications subsystem, which can include without limitation a modem, a network card (wireless or wired), an infra-red communication device, a wireless communication device and/or chipset (such as a Bluetooth device, an 802.11 device, a WiFi device, a WiMax device, cellular communication facilities, etc.), and/or the like. The communications subsystem may permit data to be exchanged with a network, and/or any other devices described herein. The network may comprise a local area network (LAN) or a network such as the Internet, or a combination. In many embodiments, the computer devices may further include a working memory, which can include a RAM or ROM device, as described above. The system may optionally include processing acceleration to assist with processing, such as arithmetic computations, graphical computations, and the like.

The computer devices also may comprise software elements, such as located within the working memory, including an operating system and/or other code, such as one or more application programs, which may comprise computer programs performing tasks and operations described above, and/or may be designed to implement methods in accordance with the invention and/or configure systems in accordance with the invention, as described herein. Merely by way of example, one or more procedures described with respect to the method(s) discussed above might be implemented as code and/or instructions executable by a computer (and/or a processor within a computer). In one embodiment, the data generating and presenting operations are implemented as application programs. In the description herein, references to “interface” and “processor” and “application” should be understood as referring to hardware, software, and combinations of the two, either as independent components (hardware, software, and/or both) for each interface, processor, or application, or as integrated components combined with one or more other components.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention

We claim:

1. A computer method of processing, the method comprising:
mapping query results onto domains comprising a plurality of predetermined conceptual groupings wherein the query results comprise database records identified by a search engine in response to a current search query;
determining a population ranking of the domains onto which the query results are mapped in accordance with query-click behavior collected from a user population for the current search query;
determining a user ranking of the domains in accordance with query-click behavior collected from the user for prior search queries not including the current search query;
generating a merged ranking of the query results according to the population ranking and the user ranking.

2. The computer method according to claim 1, wherein the merged ranking comprises a merged score for each of the domains onto which the query results are mapped, and generating the merged ranking comprises providing the query results in an ordering according to the merged scores of the domains.

3. The computer method according to claim 1, wherein the current search query comprises one or more words, and the query results comprise database records identified by the search engine in response to at least one word of the current search query.

4. The computer method according to claim 1, wherein generating a merged ranking comprises generating a merged ranking such that no domain ranking in the merged ranking is different from its ranking in the population ranking by more than a predetermined ranking difference.

5. The computer method according to claim 1, wherein collecting query-click behavior from a user population comprises:
creating a query-click message in response to selection of a database record from among a listing of database records in query results by a member of the user population, wherein the query-click message identifies the domain onto which the selected database record is mapped;
maintaining a list of the query-click messages according to the domains on which the respective query-click messages are mapped;
generating statistics on the list of query-click messages that indicate query-click behavior of the user population.

6. A computer processing system comprising:
a query results mapper that maps query results onto domains comprising a plurality of predetermined conceptual groupings wherein the query results comprise database records identified by a search engine in response to a current search query;
a population ranking processor that determines a population ranking of the domains onto which the query results are mapped in accordance with query-click behavior collected from a user population for the current search query;
a user ranking processor that determines a user ranking of the domains in accordance with query-click behavior collected from the user for prior search queries not including the current search query; and
a score processor that generates a merged ranking of the query results according to the population ranking and the user ranking

7. The system as in claim 6, wherein the score processor generates a merged score for each of the domains onto which the query results are mapped, and provides the query results in an ordering according to the merged scores of the domains.

8. The system as in claim 6, wherein the current search query comprises one or more words, and the query results comprise database records identified by the search engine in response to at least one word of the current search query.

9. The system as in claim 6, wherein the score processor generates a merged ranking such that no domain ranking in the merged ranking is different from its ranking in the population ranking by more than a predetermined ranking difference.

10. The system as in claim 6, wherein the population ranking processor creates a query-click message in response to selection of a database record from among a listing of database records in query results by a member of the user population, wherein the query-click message identifies the domain onto which the selected database record is mapped, maintain a list of the query-click messages according to the domains on which the respective query-click messages are mapped, and generates statistics on the list of query-click messages that indicate query-click behavior of the user population.

11. A computer method of processing, the method comprising:
computing a click query probability “p(click|query)” at a ranking system computer, wherein the click query probability defines, for each domain represented in search query results, probability of a click on a result in the domain given a current search query, wherein each domain is a domain of a predetermined set of conceptual domains;
computing a ranking of the domains represented in the search query results according to the computed click query probabilities;
computing a click user probability “p(click|user)” for each domain represented in the search query results, the click user probability comprising probability of a click on a result in each domain given a current user;
computing a ranking of the domains by click user probability “p(click|user)”;
computing a merged score “ms” that combines a ranking of the domain, the ranking of the domain by click query probability “p(click|query)”, and the ranking of the domain by click user probability “p(click|user)”;
computing a final ranking of the domains represented in the search query results from a highest “ms” computed score to a lowest “ms” computed score.

12. The computer method according to claim 11, wherein the click query probability for a query is defined as:
p(click|query)=s+no. of clicks on results from the query in the domain/no. of domains*s+no. of clicks on results from the query in all domains,
where s=a predetermined smoothing count.

13. The computer method according to claim 11, wherein the click user probability for a user is defined as:
p(click|user)=s+no. of clicks by the user on results in the domain/no. of domains*s+no. of clicks by the current user on results in all domains,
where s=a predetermined smoothing count.

14. The computer method according to claim 11, wherein the merged score ms is defined as:
ms=1/(ro+1)+wrq/(rq+1)+wru/(ru+1), wherein:
ro=original ranking of search results on conceptual domains
rq=rank by p(click|query)
ru=rank by p(click|user)
wrq=heuristic weight of rq in final rank
wru=heuristic weight of ru in final rank.
